(19) United States
(12) Patent Application Publication
(10) Pub. No.: US 2006/0224681 A1
(43) Pub. Date: Oct. 5, 2006

(54) Mobile communications device e-mail message delivery

(76) Inventor: Charles Stewart Wurster, Incinitas, CA (US)

Correspondence Address: FISH & RICHARDSON, PC, P.O. BOX 1022, MINNEAPOLIS, MN, 55440-1022, US

(21) Appl. No.: 11/392,153

(22) Filed: Mar. 29, 2006

Related U.S. Application Data
(60) Provisional application No. 60/666,330, filed on Mar. 29, 2005.

(51) Int. Cl. G06F 15/16

(52) U.S. Cl. 709/206

(57) ABSTRACT

An e-mail message addressed to an e-mail message address is received. From this e-mail message, characteristics of the e-mail message matching one or more predetermined conditions are identified. Thereafter, a transmission of a notification message to a mobile communications device associated with the e-mail message address may be initiated. The notification message can comprise an application identifier operable to activate (e.g., launch, wake, change operating state, etc.) an associated application installed on the mobile communications device. In other variations, the notification message is directed to a pre-defined port on the mobile communications device to which the application is registered which results in the activation of the application. Related methods, apparatuses, systems, and computer program products are also described.

### TECHNICAL FIELD

The subject matter described herein relates to selectively delivering e-mail messages to a mobile communications device.

### BACKGROUND

Conventional systems for viewing e-mail message on a wireless device fall into one of two categories, either they are pull systems or they are push systems.

Pull based e-mail message systems require the user to actively check to see if any new e-mail messages have arrived at the mail server. There are two main drawbacks to this type of arrangement. First, frequent checking for new messages when there are none consumes time, network bandwidth, and power. Second, infrequently checking for messages may result in the user not being aware of an important e-mail message for a prolonged period of time. These same drawbacks are also present in systems that perform a timed pull (that is a check for new mail every X minutes).

Push based e-mail message systems typically push the contents of messages that meet certain criteria to the wireless device. One problem with this system is that the criteria used to determine what messages to send to the wireless device are never perfect. As a result messages are sent to the wireless device that are not required. Another general problem with these systems is that they typically require complicated synchronization schemes that require custom software installations on either the mail server or on desktop clients that serve to redirect the mails to the wireless device.

### SUMMARY

In one aspect, an e-mail message addressed to an e-mail message address is received. From this e-mail message, characteristics of the e-mail message matching one or more predetermined conditions are identified. Thereafter, a transmission of a notification message to a mobile communications device associated with the e-mail message address may be initiated. The notification message may comprise an application identifier operable to activate (e.g., launch, wake, change operating state, etc.) an associated application installed on the mobile communications device.

In some implementations, the initiation of the transmission of the notification message includes generating a request containing information associated with the e-mail message, and transmitting the request to a notification server to generate the notification message and transmit the notification message to the mobile communications device.

The notification message may take many forms, including an SMS message or other data format capable of encapsulating an application identifier (i.e., information to activate the application). The application identifier may comprise a BREW application identifier, a non-BREW application identifier, a URL identifying a location of the application or an application launcher.

The notification message may be transmitted to a pre-defined port of the mobile communications device to which the application is registered. With this arrangement, receipt of the notification message on the port results in the application being activated. Transmitting the notification message to the port may be preceded by the opening of a socket connected to the port on the mobile communications device.

Once the notification message is received by the mobile communications device, an alert may be displayed notifying a user of the received e-mail message. Additionally or alternatively, the application can fetch at least a portion of the e-mail message from the mail server which can be displayed to the user via a graphical user interface. The alert can include header information from the e-mail message such as sender, or subject, and optionally a portion of the body of the e-mail message. The alert can also include information characterizing multiple received e-mail messages (e.g., “You have 5 unread e-mail messages”, etc.). The amount of information for inclusion in such alerts can in some instances be customizable by a user.

In some variations, the receipt of the notification message causes the mobile communications device to initiate a synchronization of a data store on the mobile communications device with e-mail messages stored on a mail server. Thereafter, the user can review a locally stored copy of the e-mail message on the mobile communications device.

In an interrelated aspect, an e-mail message addressed to an e-mail message address is received. Characteristics of the e-mail message that match one or more predetermined conditions are identified. This identification results in the initiation of a transmission of a notification message to a pre-defined port of a mobile communications device associated with the e-mail message address. The receipt of the notification message on the pre-defined port is operable to activate an associated application installed on the mobile communications device.

In a further interrelated aspect, a mobile communications device receives a notification message generated in response to a receipt of an e-mail message containing certain predetermined characteristics. The notification message contains an application identifier to activate an application installed on the mobile communications device after receipt of the notification message. Optionally, a notification alert on a graphical user interface of the mobile communications device can be displayed that characterizes at least a portion of the e-mail message in response to the receipt of the notification message.

In still another interrelated aspect, an apparatus comprises a mail server, a process on a server, and a notification server. The mail server is operable to receive an e-mail message associated with an e-mail message address. The process on a server is operable to determine whether characteristics of the e-mail message match one or more predetermined conditions. The notification server is operable to send a notification message to a mobile communications device associated with the e-mail message address. Such a notification message may comprise an application identifier for activating an application installed on the mobile communications device.

In yet a further interrelated aspect, a mobile communications device comprises a receiver and a graphical user interface. The receiver may be operable to receive a notification message that was generated in response to the receipt of an e-mail message containing certain characteristics matching one or more predetermined conditions. The notification message may include an application identifier which results in an activation of an application installed on the mobile communications device when the notification message is received. The graphical user interface may be operable to display a notification alert generated by the application in response to the receipt of the notification message by the receiver. Such notification alert may characterize at least a portion of the e-mail message such as sending party, subject of the e-mail message, body of the e-mail message, and the like.

The subject matter described herein provide numerous advantages. As compared to conventional pull systems, the present techniques allow a user to receive an alert notification of new messages while optimally using device and network resources.

The present subject matter also provides many improvements over conventional push systems using standard mail protocols and optimizing device and network resources. For example, alerts may be generated by a mail server, a desktop mail client, a proxy server or the like. The alert need not contain a whole message and so less bandwidth may be consumed. Moreover, a client may manipulate or otherwise directly modify e-mail messages on a server thereby obviating time and resource consuming resynchronization. The client (and therefore the user) is provided with greater control over which e-mail messages may be downloaded.

Computer program products which may be embodied on computer readable-material, are also described. Such computer program products include executable instructions that cause a computer system to conduct one or more of the acts described herein.

Similarly, computer systems are also described. These computer systems may include a processor and a memory coupled to the processor. The memory may encode one or more programs that cause the processor to perform one or more of the acts described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 illustrates a schematic diagram illustrating a mail server wirelessly coupled to a mobile communications device;

FIG. 2 illustrates a first process flow diagram showing an implementation of the subject matter described herein; and

FIGS. 3A and 3B illustrate a second process flow diagram showing an implementation of the subject matter described herein.

### DESCRIPTION

There are a great many possible implementations and variations of the invention, too many to describe herein. Some possible implementations that are presently preferred are described below. It cannot be emphasized too strongly, however, that these are descriptions of implementations of the invention, and not descriptions of the invention, which is not limited to the detailed implementations described in this section but is described in broader terms in the claims.

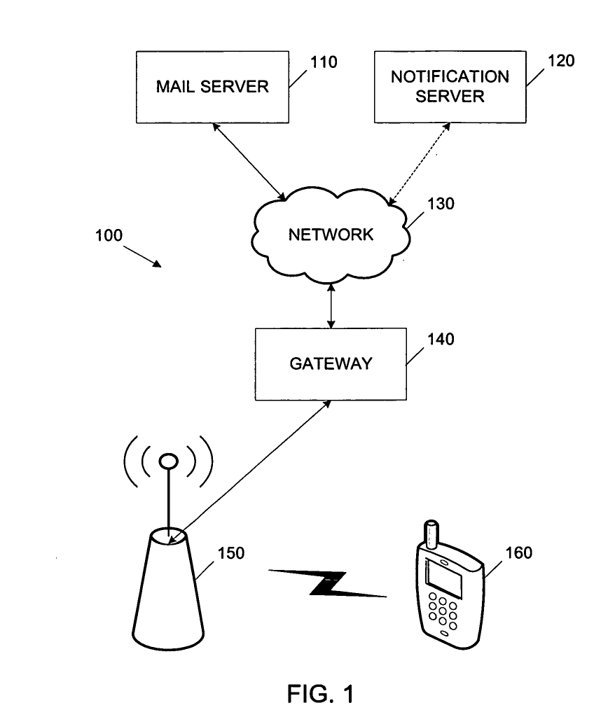

FIG. 1 illustrates a system 100 in which a mail server 110 is operable to generate messages for transmission over a network 130. A gateway 140 is coupled to the network 130 and acts to transmit messages, such as SMS messages, via a wireless communication network 150 which in turn is operable to communicate with a mobile communications device 160. In some variations, a notification server 120 is additionally operable to generate messages for transmission via the network 130.

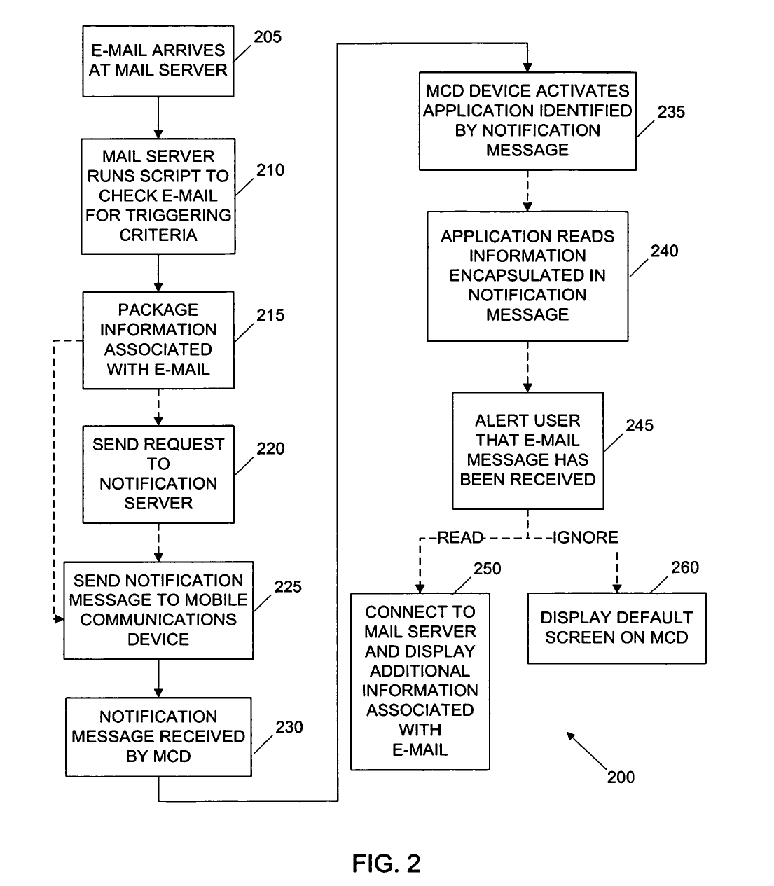

FIG. 2 is a process flow diagram 200 showing one implementation of the subject matter described herein, which may be utilized, for example, in connection with system 100 of FIG. 1. An e-mail message is received, at 205, by a mail server. In response, the mail server, at 210, runs a script to check whether the e-mail message contains triggering criteria (i.e., whether the contents of the e-mail message match one or more predetermined conditions). The criteria may include key words in the body of the e-mail message, data associated with the e-mail message header (TO, FROM, BCC, priority, subject, etc.), or it may simply comprise the receipt of a message (i.e., the triggering criteria/matching conditions may be met whenever a message is received). The script can be attached to the account associated with the e-mail message address and include a phone number of a mobile communications device to be alerted when the triggering criteria is met. If such triggering criteria is identified, information associated with the e-mail message, at 215, is packaged. In one variation, at 220, a request is sent to a notification server to generate a notification message. This request contains information characterizing the e-mail message such as, for example, the account that received the e-mail message, the name and address of the sender of the e-mail message, the subject of the e-mail message, and the like. The request may also contain the phone number of the mobile communications device or some other user identifier. The request may comprise, in some variations, a further e-mail message. As an alternative, the mail server generates a notification message directly. In either scenario, the notification message is sent, at 255, to a mobile communications device. The notification message may initially comprise an e-mail message which is subsequently converted into an SMS message by an intermediary gateway. For mobile communications devices utilizing the BREW platform, the received notification message may comprise, for example, a BREW SMS wake-up message.

After the notification message is, at 230, received by the mobile communications device, the mobile communication device (MCD), at 235, determines that the notification message is application targeted and activates an application identified by the notification message. Activation of the application can include waking the application, launching the application, or some other action to place the application in a state to process the notification message and/or its payload. Thereafter, in some variations, at 240, the application reads information encapsulated in the notification message. Based on the encapsulated information, the user may, at 245, be alerted that an e-mail message has been received. This alert may simply notify a user that a message has been received, or in the alternative, it may include some information regarding the e-mail message. The alert may allow the user to select whether he or she wishes to read the e-mail message or disregard it. In the former case, at 250, the application may connect to the mail server to fetch at least a portion of the message and display some or all of the e-mail message on the mobile communications device. In the latter case, at 255, the mobile communications device will either return to a default screen or the screen displayed prior to the alert. Actions that occur subsequently to the receipt of the notification message may be customized based on, for example, user preferences. In particular, the content and format of an alert to a user may be predefined. For example, a user can specify that the sender and a subject of the e-mail message are displayed and how such information is conveyed.

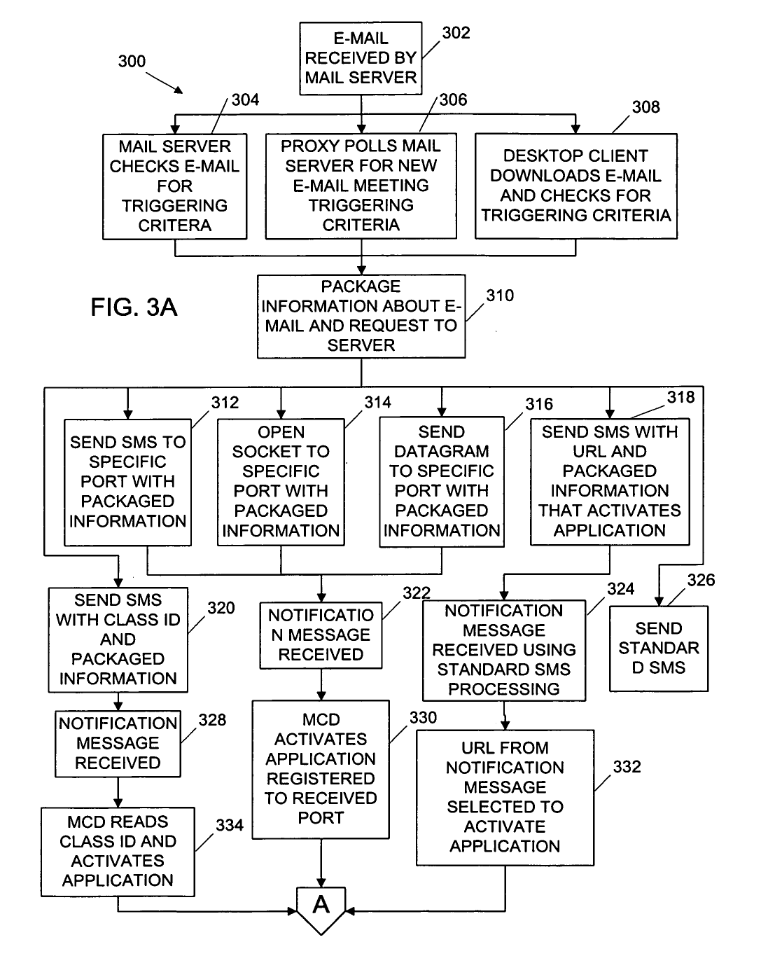

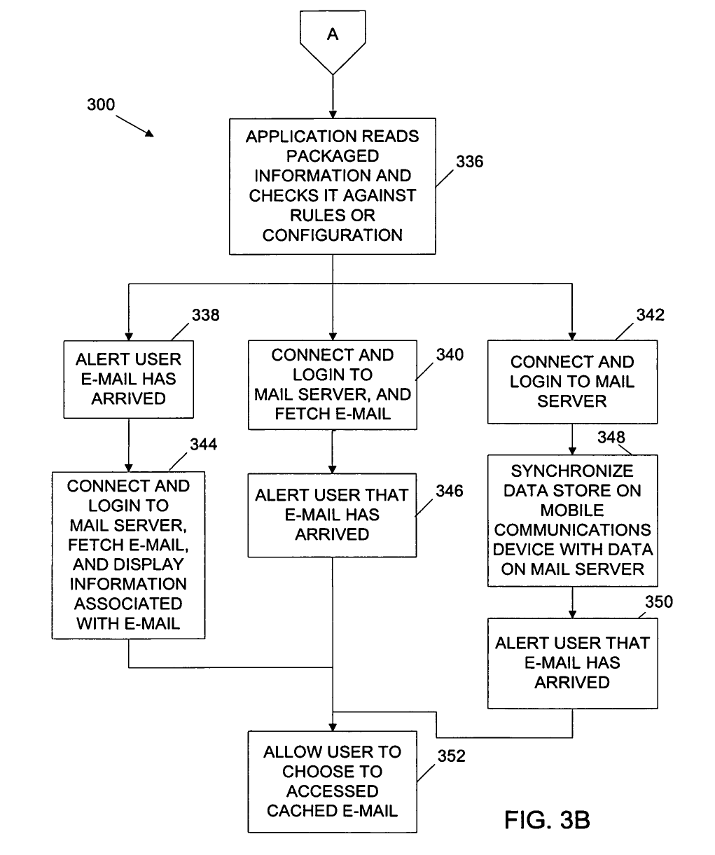

FIGS. 3A-3B illustrate a process flow diagram 300 showing several implementations of the subject matter described herein. These implementations may be adopted singly, or if desired, in partial or complete combination. An email, at 302, is received by a mail server. In one variation, the mail server, at 304, checks whether the contents or the header of the e-mail message contain any triggering criteria which could result in an initiation and/or generation of a notification message for transmission to a mobile communications device associated with a recipient of the e-mail message (i.e., the person to whom the e-mail message was addressed). The mail server can check for triggering criteria by running scripts on behalf of the user every time an e-mail message is received. The scripts may be designed so that they know what account the message came in on, what criteria, if any, should be used to decide whether it should be sent to the mobile device, and what the details of the incoming message are. However, not all mail servers permit modification and so other variations can be implemented that do not require such modifications.

In another variation, a proxy service or other intermediary periodically, at 306, polls the mail server to fetch or otherwise obtain an e-mail message and to check such e-mail message to determine whether it includes any triggering criteria. Optionally, the service may be installed on a machine other than the desktop client of the user while still avoiding the modification of the mail server. This arrangement may be utilized in situations in which the desktop of the user does not always remain on and connected to the network (e.g., a laptop). Additionally, this arrangement can allow the service checking for new e-mail messages to be located anywhere (inside the firewall or outside) as long as it can log into the e-mail message account.

In yet another variation, a client installed on a desktop (e.g., Microsoft Outlook, Microsoft Outlook Express, Eudora, ThunderBird, etc.), at 308, periodically fetches e-mail message from the mail server and determines whether the e-mail message contains triggering criteria. The desktop client can be used when the configuration of the mail server cannot be altered to include a server script. With such arrangements, the desktop client may be configured to send out a message (e.g., an e-mail message) to the notification server upon receiving new e-mail messages. In some variations, this arrangement is accomplished by having the desktop client run a special script when a new message arrives or by sending a message to an intermediary server (e.g., the notification server).

In either of the three variations for determining whether the e-mail message contains triggering criteria, information about the e-mail message and associated information is, at 310, packaged for subsequent transmission to the mobile communications device (via, for example, a gateway). The type of notification message is dependent on the type of mobile communications device. In this regard, notification messages such as, for example, BREW directed SMS alerts, non-waking BREW SMS alerts, JAVA-based alerts may be generated.

Message filtering may be utilized so that notification messages are only selectively initiated when e-mail messages are received. Such selective alert generation may be based on a wide variety of criteria including, subject, keywords, sender, time of message transmission, message priority level, etc. The rules to establish the message filtering may be determined by a wizard process that presents a user with a series of interrogatories or other user interface mechanisms. Filtering can be set up to ignore certain messages and types of messages if possible.

Filtering can also be used such that message alerts are sent no more frequently than once per pre-defined interval (e.g., “do not send alert more frequently than once per half hour”). In addition, if alerts are set up to send information regarding multiple e-mail messages, then filtering can be configured so that the alerts are not sent until a predetermined number of messages have been received (e.g., alerts are sent every five messages).

Once the information is packaged, at 320, an the packaged information with a BREW ClassID or other application identifier is sent in an SMS (via, for example, an SMS gateway) for receipt, at 328, by the mobile communications device. After the mobile communications device receives the SMS, at 334, it reads the ClassID encapsulated in the SMS and activates an associated application.

In variations using a JAVA or a similar language, an SMS containing the packaged information can, at 312, be sent to a specific port, or, at 314, a socket to a specific port can be opened and a message sent to such port, or at 316, a datagram containing the packaged information can be sent to a specific port. With each of these three variations, at 322, a message is received by the mobile communications device which causes it, at 330, to activate an application registered to the port that received the information. Similar to BREW, JAVA applications are capable of remote activation using SMS messages. Additionally, a JAVA application installed on the mobile communications device can register to wake on a socket or datagram connection. When registering a JAVA application to receive an alert a push registry is used. This registry allows the application to register to listen on a specific port. The port in this case may be used much like a BREW ClassID to uniquely identify the listening application. When a notification message is targeted to a certain port, the notification message need not include an application identifier as the receipt of the notification message alone can cause the application to be activated.

In yet another variation, at 318, an SMS can be sent with a URL and the packaged information so that the mobile communications device, at 324, receives the SMS and accesses, at 332, the encapsulated URL to activate an application associated with the URL (which points either to the application itself or to a launcher for the application). The notification message with an embedded URL is compatible with JAVA and other machine-independent software.

As yet another alternative, a standard SMS is sent, at 326, which contains a preview of the contents of the originally sent e-mail message. In this case, if a user desires to fetch the entire e-mail message, they will have to either manually activate the local e-mail message client or alternatively use an e-mail message client that is not associated with the mobile communications device.

In each of the variations 320, 312, 314, 316, 318 in which a notification message causes an application to be activated on the mobile communications device, the application, at 336, reads the packaged information and checks it against rules or other configuration criteria. In other words, the launch of the application will not necessarily result in a notification alert or some other subsequent action occurring if the contents of the packaged information do not meet certain predefined criteria. These criteria may include, for example, the state of the phone (silent mode, sleep mode, on call, etc.) and user-defined preferences (e.g., time of day, calendar settings, etc.).

In one variation, after the initiation of the application, at 338, an alert is displayed to the user. This alert may be as simple as text stating that a new e-mail message has been received, or it may include details regarding the e-mail message such as receiver, sender, subject, time sent, etc. The user may, at this time, also be presented with the option to, at 344, login to the account, fetch at least a portion of the e-mail message and view at least a portion of the e-mail message on the display of the mobile communications device. The user may also be presented with an option, at 352, to review all of the e-mail (which may, for example, be cached on the mobile communications device).

In some variations, an alert may contain information associated with multiple messages. This information may be statistical information (e.g., the number of messages received), send/receive/subject information, and/or it may contain portions of content from the messages. In addition, the information in a multiple message alert may be minimal given payload limitations. Optionally, information regarding multiple messages may be spread across multiple alerts.

Alternatively, once the application has been activated, it may, at 340, connect to the mail server, login, at 346, to an account associated with the e-mail message address, fetch the contents of the e-mail message, and alert, at 346, the user that an e-mail message has arrived. Such an alert may be of similar nature to the alerts described above. The user can also, at 352, access the full contents of the e-mail message.

In another implementation, once the application has been activated, it may at 342, connection and login to the mail server. Thereafter, at 348, a data store on the mobile communications device is synchronized with data on mail server. With this arrangement, any e-mails present on the mail server, but not previously delivered to the mobile communications device may be made available on the mobile communications device. Similarly, any e-mails or other messages sent from the mobile communications device may be sent to the mail server for synchronization. The user may, at 350, be alerted that an e-mail message has arrived and access, at 352, the full contents of the e-mail message.

The following provides a sample workflow useful for understanding and implementing the subject matter described herein:
Application is purchased from mobile communications device carrier download server
Application configures e-mail message account and sends configuration information to mail server
Mail arrives at the mail server on a particular account
Script registered with mail server for that account is run
Script includes the account it was received on, phone number, and class ID of the application
Script is run and generates and specially formatted e-mail message to a specifically identified e-mail message address: sms@intellisyncmobile.com
Email to SMS gateway converts the e-mail message to an SMS message
After performing verifications SMS Gateway sends the SMS to carrier
Carrier's SMS system sends the message to the device
Device receives the message and software on the device checks to see if there is an application with that class ID on the phone
Application is notified that there is an SMS message
Application launches itself and checks the contents of the SMS message
Application presents the user with a notice indicating that a new message has arrived including who sent the message and what the subject is
Application allows the user to choose to read the message
If user chooses to read the message application connects to the appropriate mail server (there may be more than one account supported by the application)
Once connected the application authenticates with the mail server
Once logged in the application fetches the message list, and message contents for the selected message from the mail server and presents the message to the user

Various implementations and aspects of the subject matter described herein may be realized in digital electronic circuitry, integrated circuitry, specially designed ASICs (application specific integrated circuits), computer hardware, firmware, software, and/or combinations thereof. These various implementations and aspects may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A few implementations have been described in detail above, a great many other implementations are possible. For example, the logic flow depicted in the accompanying figures and described herein do not require the particular order shown, or sequential order, to achieve desirable results. In addition, it will be appreciated that the subject matter described herein may be used in connection with calendaring and contact applications and the like. Other implementations are within the scope of the following claims.

What is claimed is:

1. A method comprising:
receiving an e-mail message addressed to an e-mail message address;
identifying characteristics of the e-mail message matching one or more predetermined conditions; and
initiating a transmission of a notification message to a mobile communications device associated with the e-mail message address, wherein the notification message comprises an application identifier operable to activate an associated application installed on the mobile communications device.

2. A method as in claim 1, wherein initiating a transmission of a notification message comprises:
generating a request containing information associated with the e-mail message; and
transmitting the request to a notification server to generate the notification message and transmitting the notification message to the mobile communications device.

3. A method as in claim 1, wherein the notification message is an SMS message.

4. A method as in claim 1, wherein the application identifier comprises a uniform resource locator identifying a location of the application or an application launcher associated with the application.

5. A method as in claim 1, wherein the application identifier comprises a BREW wake up identifier.

6. A method as in claim 1, wherein the notification message is transmitted to a port of the mobile communications device, wherein the application is registered to the port and receipt of the notification message on the port initiates an activation of the application.

7. A method as in claim 6, further comprising: opening a socket connected to the port on the mobile communications device prior to transmission of the notification message.

8. A method as in claim 1, further comprising: displaying an alert on the mobile communications device in response to the transmission of the notification message.

9. A method as in claim 1, wherein the displayed alert comprises a graphical user element that initiates a display of content information from the e-mail message.

10. A method as in claim 8, wherein the displayed alert includes content information from the e-mail message.

11. A method as in claim 8, wherein the displayed alert includes statistical information associated with more than one e-mail message.

12. A method as in claim 1, wherein the activating the associated application comprises: launching the associated application.

13. A method as in claim 1, wherein activating the associated application comprises: waking the associated application.

14. A method as in claim 1, further comprising: fetching, by the application, at least a portion of the e-mail message in response to the transmission of the notification message.

15. A method as in claim 1, further comprising: synchronizing a data store on the mobile communications device with e-mail messages stored on a mail server in response to the transmission of the notification message.

16. A method comprising:
receiving an e-mail message addressed to an e-mail message address;
identifying characteristics of the e-mail message matching one or more predetermined conditions; and
initiating a transmission of a notification message to a pre-defined port of a mobile communications device associated with the e-mail message address, wherein receipt of the notification message on the pre-defined port is operable to activate an associated application installed on the mobile communications device.

17. A method comprising:
receiving, by a mobile communications device, a notification message, wherein the notification message is generated in response to a receipt of an e-mail message containing certain predetermined characteristics and comprises an application identifier to activate an application installed on the mobile communications device; and
activating the application client in response to the receipt of the notification message.

18. A method as in claim 17, further comprising: displaying a notification alert on a graphical user interface of the mobile communications device identifying at least a portion of the e-mail message.

19. An apparatus comprising:
an mail server to receive an e-mail message associated with an e-mail message address;
a processor to determine whether characteristics of the e-mail message match one or more predetermined conditions; and
a notification server to send a notification message to a mobile communications device associated with the e-mail message address, wherein the notification message comprises an application identifier for activating an application installed on the mobile communications device.

20. A mobile communications device comprising:
a receiver to receive a notification message, wherein the notification message is generated in response to the receipt of an e-mail message containing certain characteristics matching one or more predetermined conditions and comprising an application identifier to activate an application installed on the mobile communications device; and
a graphical user interface to display a notification alert generated by the application in response to the receipt of the notification message by the receiver, the notification alert characterizing at least a portion of the e-mail message.
